(19) United States
(12) Patent Application Publication
(10) Pub. No.: US 2010/0010990 A1
(43) Pub. Date: Jan. 14, 2010

(54) PROGRESS INFORMATION OUTPUT METHOD, MEDIUM STORING PROGRESS INFORMATION OUTPUT PROGRAM, AND PROGRESS INFORMATION OUTPUT APPARATUS

(75) Inventor: Koji Tsukamoto, Kawasaki (JP)

Correspondence Address: Fujitsu Patent Center;C/O CPA Global, P.O. Box 52050, Minneapolis, MN, 55402, US

(73) Assignee: Fujitsu Limited, Kawasaki (JP)

(21) Appl. No.: 12/498,831

(22) Filed: Jul. 7, 2009

(30) Foreign Application Priority Data
Jul. 10, 2008 (JP) 2008-180775

(51) Int. Cl. G06F 17/30

(52) U.S. Cl. 707/5; 707/E17.014

(57) ABSTRACT

A progress information output method executed by a computer includes acquiring a set of similar applications, the contents of which are similar to the contents of a given application, by searching a first database that stores the contents of each application using information regarding the contents of the given application as a search key, acquiring a set of progress information corresponding to the set of similar applications by searching a second database that stores progress information that is an accumulation of information on procedures performed for applications and indicates a progress of a given application, counting the number of procedures included in the set of progress information, and outputting the number of procedure types counted or an analysis result obtained using the counted number.

### CROSS-REFERENCE TO RELATED APPLICATIONS

This application is based upon and claims the benefit of priority of the prior Japanese Patent Application No. 2008-180775, filed on Jul. 10, 2008, the entire contents of which are incorporated herein by reference.

### FIELD

The embodiments herein are related to a progress information output method, a medium that stores a progress information output program, and a progress information output apparatus.

### BACKGROUND

There is a technique to output to a user a document for evaluating the significance of a patent application. A method is known in which an apparatus displays information on an application to be analyzed. For example, Japanese Laid-open Patent Publication No. 2007-241992 discloses a method in which an apparatus displays information such as a the number of years an application has been maintained, the number of citations by other patents, and whether or not an advance examination is requested. Another method that displays applications having specific relationships by a tree structure is known. For example, Japanese Laid-open Patent Publication No. 2001-76056 discloses that if an application is divided, an apparatus displays the original application and a new application in a tree structure.

### SUMMARY

According to an aspect of the invention, a progress information output method executed by a computer includes; acquiring a set of similar applications, the contents of which are similar to the contents of a given application, by searching a first database that stores the contents of each application using information regarding the given application as a search key; acquiring a set of progress information corresponding to the set of similar applications by searching a second database that stores progress information that accumulates information on procedures performed for applications and that indicates the progress of each application using each similar application as a search key; counting the number of procedures included in the set of progress information and classified by procedure type; and outputting the number of procedures counted in association with the procedure type or an analysis result obtained using the counted number.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an overview of a progress information output apparatus according to a first embodiment;

FIG. 2 is a block diagram illustrating a configuration of the progress information output apparatus according to the first embodiment;

FIG. 3 illustrates an identification information and progress information table storage unit according to the first embodiment;

FIG. 4 illustrates a progress information and frequency table storage unit according to the first embodiment;

FIG. 5 illustrates a progress information and ratio table storage unit according to the first embodiment;

FIG. 6 illustrates a ratio and color table storage unit according to the first embodiment;

FIG. 7 illustrates an example of layout information stored in a layout information storage unit according to the first embodiment;

FIGS. 8 to 10 illustrate examples of information output from an output unit by a progress information processing unit according to the first embodiment;

FIG. 11 is a flowchart illustrating a processing flow of an identification information and progress information table creation unit according to the first embodiment;

FIG. 12 is a flowchart illustrating a processing flow of outputting progress information according to the first embodiment;

FIG. 13 is a block diagram illustrating a configuration of a progress information output apparatus according to a second embodiment;

FIGS. 14A and 14B illustrate a progress information and identification information table storage unit according to the second embodiment;

FIGS. 15A and 15B illustrate a characteristics list storage unit according to the second embodiment;

FIG. 16 illustrates a progress information and important characteristics table storage unit according to the second embodiment;

FIG. 17 illustrates an example of information output from an output unit by a progress information processing unit according to the second embodiment;

FIG. 18A is a first flow chart and FIG. 18 B is a second flowchart illustrating processing flows of outputting progress information according to the second embodiment;

FIG. 19 is a block diagram illustrating a configuration of the progress information output apparatus according to a third embodiment;

FIG. 20 illustrates a comment table storage unit according to the third embodiment;

FIG. 21 illustrates an example of information output from an output unit by the progress information processing unit according to the third embodiment;

FIG. 22 is a flowchart illustrating a processing flow of outputting progress information according to the third embodiment; and

FIG. 23 illustrates the configuration of a program of a progress information output apparatus according to the first embodiment;

### DESCRIPTION OF EMBODIMENTS

There is a drawback with the above described prior art in that it may be necessary for the application to be in progress in order to analyze an examination of an application.

Thus, the inventor devised a progress information output method, a medium that stores a progress information output program, and a progress information output apparatus that may output information for evaluation regardless of an examination status.

Hereunder, embodiments of the progress information output method and the progress information output program according to the invention will be described in detail by referring to the accompanying drawings. First, an overview of the progress information output apparatus, a configuration of the apparatus, and a processing flow according to a first embodiment will be described, and then other embodiments will be described.

### Embodiment 1

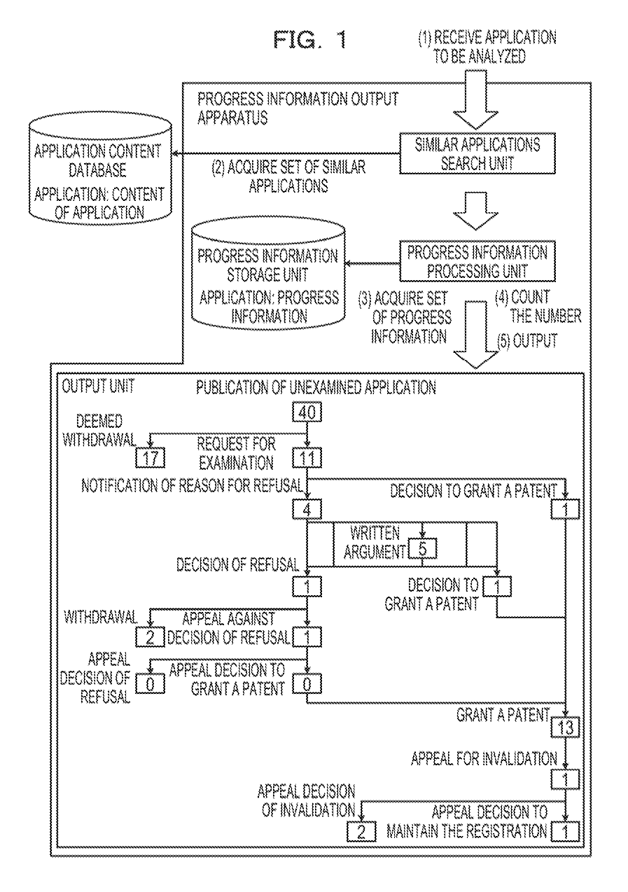

First, an overview of the progress information output apparatus of the first embodiment will be described by referring to FIG. 1. FIG. 1 illustrates an overview of a progress information output apparatus according to the first embodiment. Hereunder, as an example, Japanese patent procedures will be used for an explanation. However, this invention is not limited to patent procedures in Japan, and may be applicable to patent procedures in various countries.

As illustrated in FIG. 1, the progress information output apparatus of the first embodiment is connected to an application content database that stores the contents of each application. The progress information apparatus includes a progress information storage unit for storing progress information that is an accumulation of procedure information for each application.

The progress information output apparatus of the first embodiment receives an application to be analyzed as illustrated in (1) of FIG. 1. After that, a similar applications search unit of the progress information output apparatus searches the application content database using information regarding the contents of an application to be analyzed as a search key, as illustrated in (2) of FIG. 1, and acquires a set of similar applications, the contents of which are similar to the application to be analyzed.

As illustrated in (3) of FIG. 1, a progress information processing unit of the progress information output apparatus searches the progress information storage unit using each of the similar applications included in the set of similar applications as a search key and acquires a set of progress information corresponding to the set of similar applications.

Then, as illustrated in (4) of FIG. 1, the progress information output apparatus of the first embodiment classifies procedure information included in the acquired set of progress information by procedure type, and counts the number of procedures belonging to each of the classified procedure types.

As illustrated in (5) of FIG. 1, the progress information output apparatus of the first embodiment outputs the counted number of procedures or an analysis result based on the number of procedures in association with the procedure type to an output unit.

Thus, the progress information output apparatus of the first embodiment is able to output information for evaluation regarding an application to be analyzed regardless of the examination status. In other words, the actions of searching a group of applications similar to the application to be analyzed, collecting the progress information of the group of applications, counting the number for procedure types, such as “Request for Examination” or “Decision of Refusal,” and outputting the results may provide information for evaluating applications which have not gone through all the procedures.

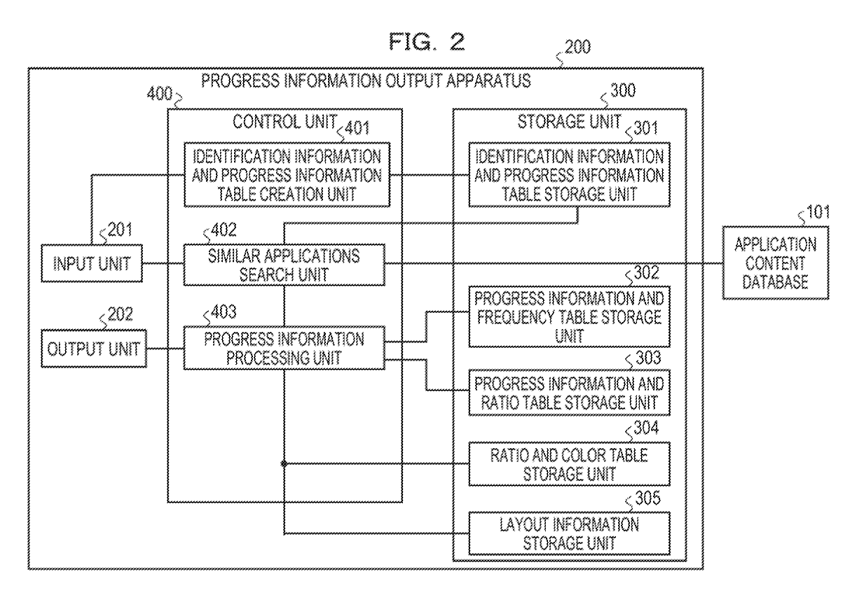

Now, the functions of a progress information output apparatus illustrated in FIG. 1 will be described by referring to FIG. 2. FIG. 2 is a block diagram illustrating a configuration of the progress information output apparatus 200. As illustrated in FIG. 2, the progress information output apparatus 200 is connected to an application content database 101 and includes an input unit 201, an output unit 202, a storage unit 300, and a control unit 400.

The application content database 101 is connected to the progress information output apparatus 200, which is described later, and stores the contents of each application. For example, the application content database 101 stores the contents of an application by identification information that uniquely identifies an application. Applications may include patents, utility models, and trademarks.

The input unit 201 is connected to a similar applications search unit 402 which will be described later. A user inputs an application to be analyzed into the input unit 201. For example, the user inputs the details of the application to be analyzed or a keyword included in the contents of the application to be analyzed into the input unit 201. The input unit 201 transmits the input application to be analyzed to the similar applications search unit 402. The input unit 201 may be a keyboard and/or a mouse. The output unit 202 is connected to a progress information processing unit 403 and outputs the information received from the progress information processing unit 403 onto, for example, a screen. The output unit 202 may include a monitor.

The storage unit 300 stores data required for displaying various progress information by a control unit 400. The storage unit 300 includes an identification information and progress information table storage unit 301, a progress information and frequency table storage unit 302, a progress information and ratio table storage unit 303, a ratio and color table storage unit 304, and a layout information storage unit 305.

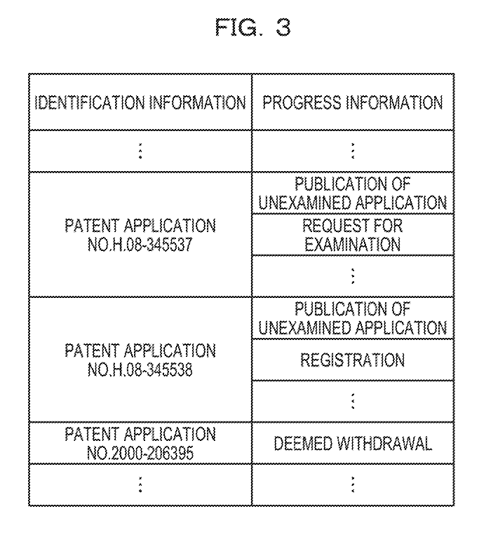

The identification information and progress information table storage unit 301 stores progress information in association with identification information as illustrated in FIG. 3. FIG. 3 illustrates an identification information and progress information table storage unit 301 according to the first embodiment.

The progress information is an accumulation of procedure information performed for an application indicating the progress of the application. The procedure information includes information on procedures and actions performed, for example, by an applicant, an examiner, an appeal examiner, and/or the Commissioner of the Patent Office. The type of procedure refers to the types of procedures and actions included in the progress information such as, for example, “Publication of Unexamined Application”, “Request for Examination”, and “Submission of Argument.”

In the example illustrated in FIG. 3, the identification information and progress information table storage unit 301 stores procedure information “Publication of Unexamined Application”, and “Request for Examination” as progress information by associating the procedure information with the identification information “Patent Application No. H. 08-345537.” The procedure information “Publication of Unexamined Application” associated with the identification information “Patent Application No. H. 08-345537” indicates that the application identified as “Patent Application No. H. 08-345537” was published as an unexamined application.

Information stored in the identification information and progress information table storage unit 301 is input by an identification information and progress information table creation unit 401, which will be described later, and used by the similar applications search unit 402.

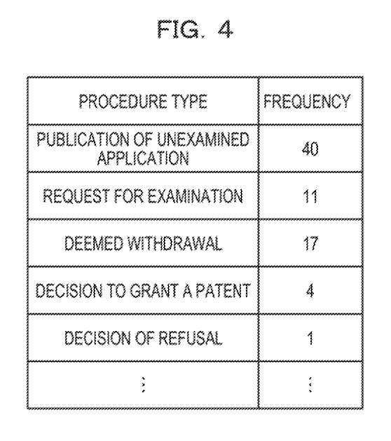

The progress information and frequency table storage unit 302 is connected to the progress information processing unit 403 and stores a frequency for each procedure type as illustrated in FIG. 4. For example, the unit 302 stores a frequency “40” in association with the procedure type “Publication of Unexamined Application.” FIG. 4 illustrates a progress information and frequency table storage unit 302 according to the first embodiment.

The “frequency” indicates the number of procedures associated with a procedure type. The number of procedures for each procedure type is acquired from the identification information and progress information table storage unit 301 by the similar applications search unit 402. For example, the frequency “40” associated with the procedure type “Publication of Unexamined Application” indicates that the similar applications search unit 402, which will be described later, acquires information indicating that the number of “Publication of Unexamined Application” procedures is 40 from the identification information and progress information table storage unit 301. The number of procedures may correspond to the number of similar applications because one procedure of the same procedure type is conducted in each similar application.

Information stored in the progress information and frequency table storage unit 302 is input by the progress information processing unit 403 and used by the progress information processing unit 403.

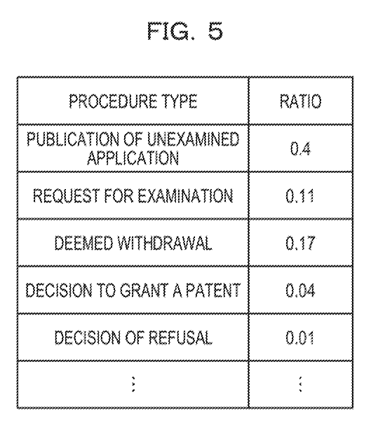

The progress information and ratio table storage unit 303 is connected to the progress information processing unit 403. As illustrated in FIG. 5, the progress information and ratio table storage unit 303 stores, for each type of procedure, a ratio of the number of similar applications that correspond to the type of procedure among the total number of similar applications included in the set of similar applications. FIG. 5 illustrates a progress information and ratio table storage unit 303 according to the first embodiment. In the example of FIG. 5, the progress information and ratio table storage unit 303 stores the ratio “0.4” in association with the procedure type “Publication of Unexamined Application.”

The ratio “0.4” associated with the procedure type “Publication of Unexamined Application” indicates that similar unexamined applications that have been published account for 40% of all of the similar applications.

Information stored in the progress information and ratio table storage unit 303 is input by and used by the progress information processing unit 403.

Now, differences among information stored in the identification information and progress information table storage unit 301, the progress information and frequency table storage unit 302, and the progress information and ratio table storage unit 303 will be described. Information stored in the progress information and frequency table storage unit 302 and the progress information and ratio table storage unit 303 is information regarding the set of similar applications whose contents are similar to the application to be analyzed. Meanwhile, information stored in the identification information and progress information table storage unit 301 includes information not only for the application to be analyzed but also information for other applications.

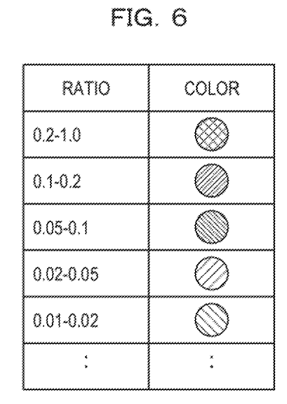

The ratio and color table storage unit 304 is connected to the progress information processing unit 403. As illustrated in FIG. 6, the ratio and color table storage unit 304 stores colors used by the progress information processing unit 403 when a procedure type that corresponds to a ratio within a range indicated in the ratio and color table storage unit 304 is output. FIG. 6 illustrates a ratio and color table storage unit 304 according to the first embodiment. In the example of FIG. 6, for the convenience of description, the differences of colors are represented by patterns.

Information stored in the ratio and color table storage unit 304 is input by a user beforehand and used by the progress information processing unit 403.

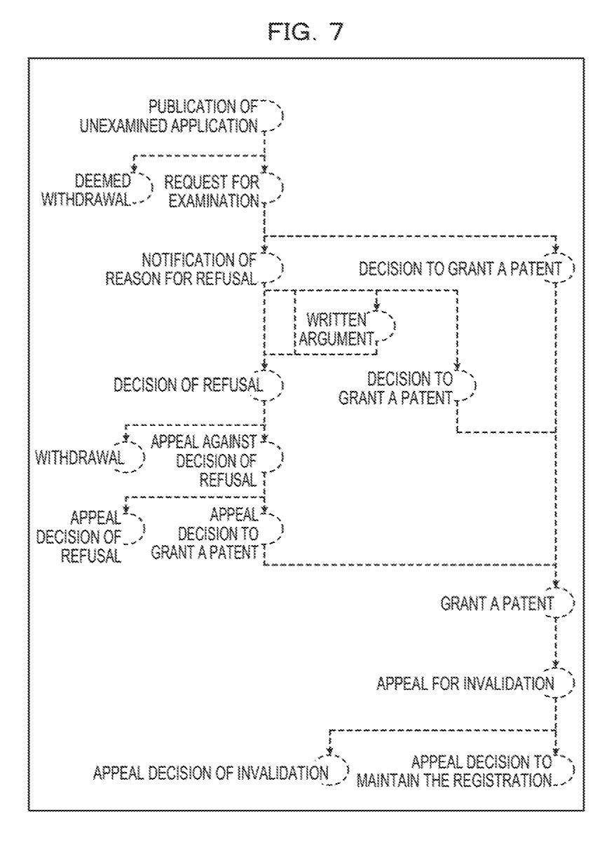

The layout information storage unit 305 is coupled to the progress information processing unit 403. As illustrated in FIG. 7, the layout information storage unit 305 stores layout information used when the progress information processing unit 403 outputs information on a screen of a display unit 202. FIG. 7 illustrates an example of layout information stored in a layout information storage unit according to the first embodiment.

In the example illustrated in FIG. 7, the layout information storage unit 305 stores layout information in which various types of procedures are displayed by taking into account the order of processing. For example, in the layout information illustrated in FIG. 7, “Notification of Reason for Refusal” and “Decision of Refusal” are connected by an arrow starting from the “Notification of Reason for Refusal” and pointing to the “Decision of Refusal.”

Information stored in the layout information storage unit 305 is input by a user beforehand and used by the progress information processing unit 403.

A control unit 400 performs processing of displaying various progress information items. The control unit 400 includes the identification information and progress information table creation unit 401, the similar applications search unit 402, and the progress information processing unit 403.

The identification information and progress information table creation unit 401 is connected to the identification information and progress information table storage unit 301. Moreover, the identification information and progress information table creation unit 401 reads organized, standardized data disclosed by, for example, the Japanese Patent Office, and extracts progress information. Then, the identification information and progress information table creation unit 401 inputs the extracted progress information into the identification information and progress information table storage unit 301 by associating the extracted data with the identification information.

Specifications of organized, standardized data are published by various countries. For example, the specification for patent gazettes issued in Japan is published in an XML (Version. 2.1) version of the organized, standardized data specification at the following address: http://www.inpit.go.jp/info/standard/data/spec/download/xml2.1.html

For example, the identification information and progress information table creation unit 401 receives and reads the organized, standardized data. Then, the identification information and progress information table creation unit 401 searches through all of the identification information included in the organized, standardized data.

For example, the identification information may be described by the following tags in the organized, standardized data. The identification information and progress information table creation unit 401 searches for and acquires identification information using, for example, a string search library (for example, String search in C++ or m//function of Perl), or a Extensible Markup Language (XML) search function parser. The example of tags illustrated below uses “application number” as the identification information: <fundamental-article-info> . . . <application-number> “Application No.” </application-number> </fundamental-article-info>

For example, the identification information and progress information table creation unit 401 selects one of the acquired identification information items, and then searches for and acquires progress information related to the identification information.

For a patent application, progress information is described by the following tags in the organized, standardized data. The identification information and progress information table creation unit 401 searches for the following tags to acquire the desired progress information. <kind-of-final-decision-code> “kind of Final Decision” </kind-of-final-decision-code> <kind-of-disposition-in-exam> “kind of disposition in exam”/kind-of-disposition-in-exam>

For example, the identification information and progress information table creation unit 401 acquires procedure information, which states that the unexamined application has been published, as progress information related to the identification information “Patent Application No. H. 08-345537.” Then, the identification information and progress information table creation unit 401 inputs the procedure information “Publication of Unexamined Application” as progress information in association with the identification information “Patent Application No. H. 08-345537” into the identification information and progress information table storage unit 301 (Refer to FIG. 3).

The identification information and progress information table creation unit 401 repeats the processing of acquiring progress information for all of the identification information items included in the organized, standardized data and inputs the acquired information into the identification information and progress information table storage unit 301.

The organized, standardized data read by the identification information and progress information table creation unit 401 may be input into the identification information and progress information table creation unit 401, for example, by a user. In the first embodiment, a method is described in which the identification information and progress information table creation unit 401 inputs identification information in association with progress information into the identification information and progress information table storage unit 301; however, this invention is not limited to this method. For example, the identification information and progress information table creation unit 401 may access the Industrial Property Digital Library and acquire progress information by reading progress information stored in the Industrial Property Digital Library.

The similar applications search unit 402 is connected to the application content database 101, the input unit 201, the identification information and progress information table storage unit 301, and the progress information processing unit 403. The similar applications search unit 402 acquires the set of similar applications and the set of progress information.

Now, processing of acquiring the set of similar applications will be described. When the similar applications search unit 402 receives an application to be analyzed from the input unit 201, the similar applications search unit 402 searches the application content database 101 using the contents of the application to be analyzed as a search key. Then, the similar applications search unit 402 acquires a set of similar applications the contents of which are similar to the application to be analyzed.

For example, the similar applications search unit 402 receives a keyword included in the contents of application to be analyzed and searches the application content database 101 using the details or a keyword of the received application. The keyword may be a word or an important phrase representing the contents of the application to be analyzed. For instance, the keywords “solar cell” may be applicable when the application is about a solar cell. The similar applications search unit 402 acquires a set of identification information that identifies each set of applications similar to the application to be analyzed. For example, the similar applications search unit 402 acquires a set of identification information that includes identification information such as “Patent Application No. H 08-345537” and “Patent Application No. H. 08-345538” as a set of similar applications.

Now, the processing of acquiring a set of progress information will be described. The similar applications search unit 402 searches an identification information and progress information table storage unit 301 using each similar application included in the acquired set of similar applications as a search key and acquires a set of progress information that corresponds to the set of similar applications. For example, the similar applications search unit 402 acquires progress information that corresponds to each identification information from the identification information and progress information table storage unit 301 using identification information items included in a set of similar applications as a search key.

For example, the similar applications search unit 402 searches the identification information and progress information table storage unit 301 using, as a search key, identification information items such as “Patent Application No. H 08-345537” and “Patent Application No. H 08-345538” included in the set of identification information acquired as a set of similar applications. Then, the similar applications search unit 402 acquires progress information such as procedure information “Publication of Unexamined Application” or “Request for Examination” when the identification information “Patent Application No. H 08-345537” is used as the search key. Moreover, the similar applications search unit 402 acquires, for example, “Publication of Unexamined Application” or “Registration” as progress information when the identification information “Patent Application No. H 08-345538” is used as the search key (Refer to FIG. 3). The similar applications search unit 402 acquires the set of progress information that corresponds to the set of similar applications by using identification information items as a search key.

The similar applications search unit 402 transmits the acquired set of progress information to the progress information processing unit 403.

The progress information processing unit 403 is connected to the output unit 202, the progress information and frequency table storage unit 302, the progress information and ratio table storage unit 303, and the ratio and color table storage unit 304. The progress information processing unit 403 is connected to the layout information storage unit 305 and the similar applications search unit 402. The progress information processing unit 403 calculates the number of procedures and a ratio for each procedure type, and outputs the information to the output unit 202.

Now, counting the number of procedures for each procedure type will be explained. The progress information processing unit 403 receives a set of progress information from the similar applications search unit 402. Then the progress information processing unit 403 classifies the procedure information included in the set of progress information by procedure type and counts the number of procedures of the classified procedure types. Then, the unit 403 inputs the number counted for each procedure type into the progress information and frequency table storage unit 302.

For example, the progress information processing unit 403 inputs the frequency “40” in association with the procedure type “Publication of Unexamined Application” into the progress information and frequency table storage unit 302 when the set of progress information includes forty “Publications of Unexamined Applications”. In other words, the progress information processing unit 403 inputs the frequency “40” in association with the procedure type “Publication of Unexamined Application” when “Publication of Unexamined Application” procedure information items are stored for the forty pieces of identification information included in the set of similar applications in the identification information and progress information table storage unit 301.

Processing of calculating a ratio for each procedure type will be explained. The progress information processing unit 403 calculates the ratio of the number of similar applications for a specific procedure type among the total number of similar applications included in the set of similar applications. The ratio is obtained by dividing the number of each procedure type by the total number of similar applications included in the set of similar applications. For example, when the number of similar applications included in a set of similar applications is “100”, and the frequency of the procedure type “Publication of Unexamined Application” is “40,” the progress information processing unit 403 obtains the ratio “0.4” by dividing “40” by “100.”

The progress information processing unit 403 inputs the ratio in association with a procedure type into the progress information and ratio table storage unit 303. For example, the unit 403 inputs the ratio “0.4” in association with the procedure type “Publication of Unexamined Application” (Refer to FIG. 5).

Now, the output of information to the output unit 202 will be described. The progress information processing unit 403 outputs a counted number or a result analyzed by using the counted number for a procedure type onto, for example, the screen of the output unit 202. For example, the progress information processing unit 403 reads layout information stored in the layout information storage unit 305 and outputs the layout information onto the screen of the output unit 202. Moreover, the progress information processing unit 403 outputs the counted number or the result analyzed by using the counted number along with the layout information output onto the screen of the output unit 202.

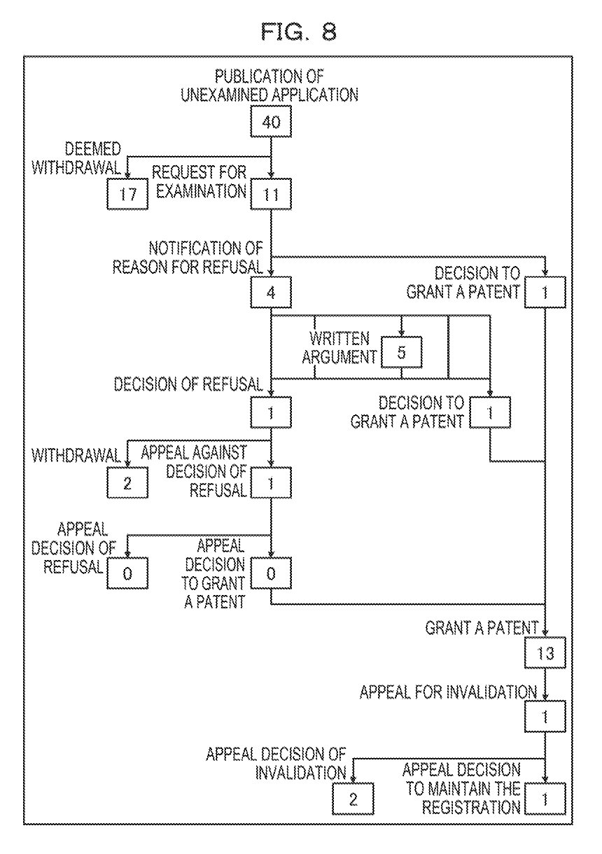

For instance, as illustrated in FIG. 8, the progress information processing unit 403 sends the frequency for each procedure type along with the layout information to the output unit 202. FIG. 8 illustrates an example of the information output via the output unit 202 by the progress information processing unit 403 according to the first embodiment.

In the example illustrated in FIG. 8, the progress information processing unit 403 reads each frequency from the progress information and frequency table storage unit 302 and, for example, outputs the frequency “40” for the procedure type “Publication of Unexamined Application” onto the screen of the output unit 202.

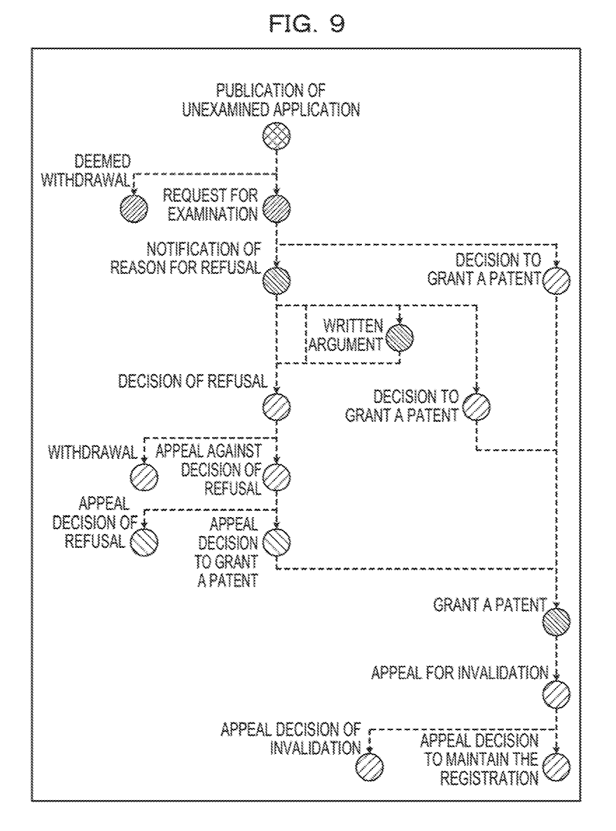

As illustrated in FIG. 9, the progress information processing unit 403 outputs the counted number or an analysis result based on the counted number to the output unit 202 by using the colors stored in the ratio and color table storage unit 304. FIG. 9 illustrates an example of information output via the output unit 202 by the progress information processing unit 403 according to the first embodiment.

In the example illustrated in FIG. 9, the progress information processing unit 403 reads each ratio from the progress information and ratio table storage unit 303. Then the progress information processing unit 403 searches the ratio and color table storage unit 304 by using each ratio as a search key and acquires each color. Then, the progress information processing unit 403 outputs, via the output unit 202, graphics using colors acquired by using the ratio for each procedure type as a search key.

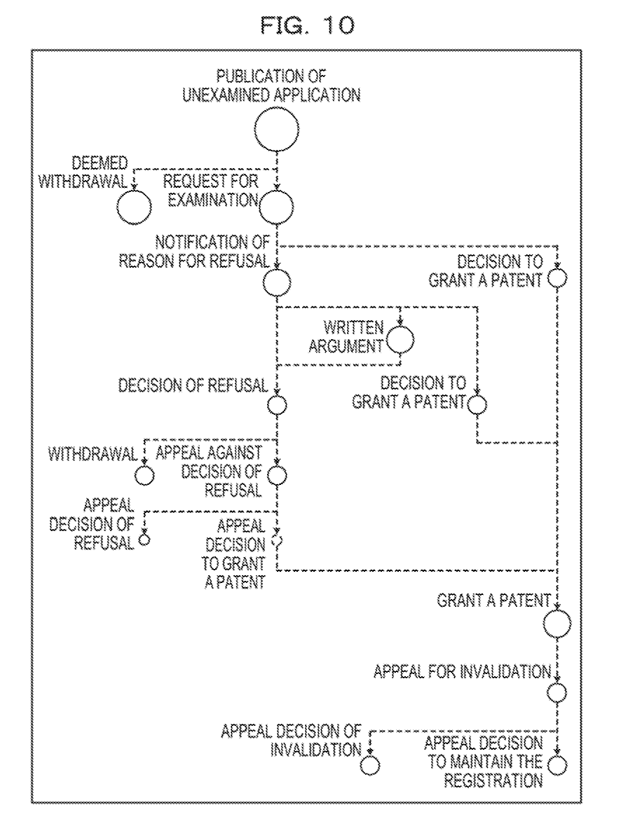

As illustrated in FIG. 10, the progress information processing unit 403 may output graphics the size of which is based on a frequency or a ratio of a procedure type to the output unit 202. FIG. 10 illustrates an example of information output via the output unit 202 by the progress information processing unit 403 according to the first embodiment.

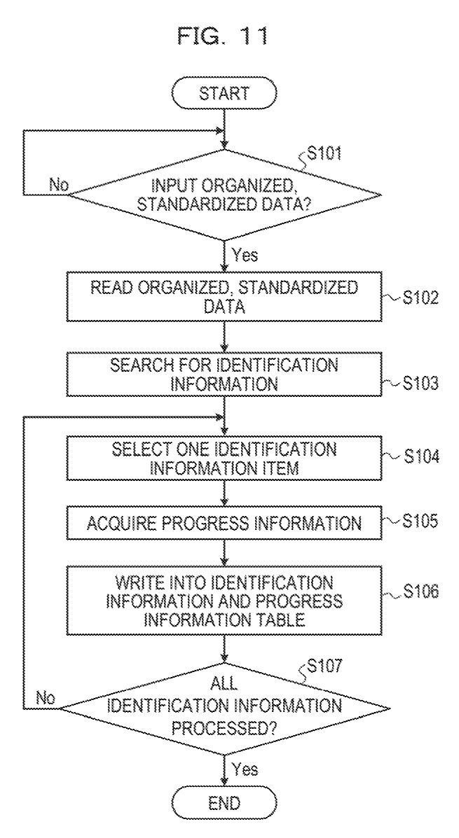

Now, a processing flow of the identification information and progress information table creation unit 401 will be described by referring to FIG. 11. FIG. 11 is a flowchart illustrating the processing flow of the identification information and progress information table creation unit 401 according to the first embodiment.

As illustrated in FIG. 11, when the identification information and progress information table creation unit 401 receives an input of organized, standardized data (Operation S101: Yes), the identification information and progress information table creation unit 401 reads the data (Operation S102). Then, the identification information and progress information table creation unit 401 searches the organized, standardized data for identification information (Operation S103).

The identification information and progress information table creation unit 401 selects one identification information item (Operation S104). For example, the identification information and progress information table creation unit 401 selects the identification information “Patent Application No. H. 08-345537.” Then the identification information and progress information table creation unit 401 acquires progress information (Step S105). For example, the identification information and progress information table creation unit 401 acquires the progress information “Publication of Unexamined Application” as procedure information for the identification information “Patent Application No. H. 08-345537.” After that, the identification information and progress information table creation unit 401 writes the progress information in association with the identification information into the identification information and progress information table in the identification information and progress information table storage unit 301 (Operation S106).

Then, the identification information and progress information table creation unit 401 judges whether or not operations from S104 to S106 have been performed for all of the identification information (Operation S107). If the identification information and progress information table creation unit 401 judges that operations have not been performed (Operation S107: No), the identification information and progress information table creation unit 401 repeats Operations from S104 to S106 until the identification information and progress information table creation unit 401 judges that processing has been performed for all of the identification information. If the identification information and progress information table creation unit 401 judges that the operations have been performed (Operation S107: Yes), the operations are completed.

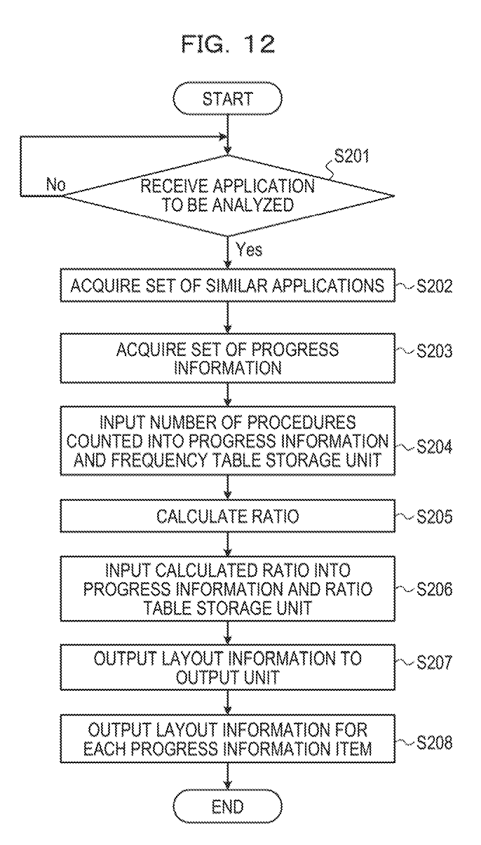

Now, processing of outputting progress information according to the first embodiment will be described by referring to FIG. 12. FIG. 12 is a flowchart illustrating a processing flow of outputting progress information according to the first embodiment.

As illustrated in FIG. 12, when the similar applications search unit 402 receives an application to be analyzed from the input unit 201 (Operation S201: Yes), the similar applications search unit 402 acquires a set of similar applications (Operation S202). In other words, the unit 402 searches the application content database 101 using information on the contents of the application to be analyzed and acquires a set of similar applications the contents of which are similar to the application to be analyzed.

Then, the similar applications search unit 402 acquires a set of progress information (Operation S203). In other words, the similar applications search unit 402 searches the identification information and progress information table storage unit 301 using each similar application included in the acquired set of similar applications as a search key and acquires a set of progress information that corresponds to the set of similar applications.

Then, the progress information processing unit 403 inputs the number of procedures counted for each of the procedure types into the progress information and frequency table storage unit 302 (Operation S204). In other words, the progress information processing unit 403 receives a set of progress information from the similar applications search unit 402, classifies the procedure information included in the set of progress information by procedure type, and counts the number of procedures for each of the classified procedure types. Then, the progress information processing unit 403 inputs the counted number for each procedure type into the progress information and frequency table storage unit 302. For example, the progress information processing unit 403 inputs “40” in association with the procedure type “Publication of Unexamined Application”.

Then, the progress information processing unit 403 calculates each ratio by dividing the counted number of each procedure type by the total number of similar applications included in the set of similar applications (Operation S205). For example, when the number of similar applications included in a set of similar applications is “100”, and the frequency for the procedure type “Publication of Unexamined Application” is “40”, the progress information processing unit 403 calculates a ratio of “0.4”. Then the progress information processing unit 403 inputs the calculated ratio in association with the procedure type into the progress information and ratio table storage unit 303 (Operation S206). For example, the unit 403 inputs the ratio “0.4” in association with the procedure type “Publication of Unexamined Application”

The progress information processing unit 403 reads layout information stored in the layout information storage unit 305 and outputs the layout information to the output unit 202 (Operation S207). The progress information processing unit 403 outputs the counted number or an analysis result based on the counted number along with the layout information output from the layout information storage unit 305 to the output unit 202 (Operation S208).

As described above, according to the first embodiment, the progress information output apparatus 200 searches the application content database 101 using information on the contents of an application to be analyzed as a search key. Then, the progress information output apparatus 200 searches the identification information and progress information table storage unit 301 using each similar applications included in the acquired set of similar applications as a search key, and acquires a set of progress information. Then, the progress information output apparatus 200 classifies the progress information included in the set of progress information by progress information type and counts the number of procedures for the classified types. Subsequently, the progress information output apparatus 200 outputs the counted number for each procedure type or an analysis result based on the counted number to the output unit. Thus, the progress information output apparatus 200 may output information for evaluating an application to be analyzed regardless of the examination status.

In other words, the disclosed progress information output apparatus 200 may output information for evaluation based on progress information, regardless of the examination status and even when an application has not been submitted for a patent yet.

According to the first embodiment, the progress information output apparatus 200 calculates a ratio for each procedure type and outputs the calculated ratio for each procedure as an analysis result. Thus, a user may easily grasp the ratio of the number of applications of each procedure type among the number of similar applications.

### Embodiment 2

In the first embodiment, a method that calculates frequencies and ratios is described. However, the invention is not limited to such a method. For example, for each procedure type, important characteristics may be output. The important characteristics may be information characteristic to and common to each set of similar applications classified by procedure type. For example, such characteristic information may include a filing year, an applicant, an inventor, a patent attorney, and/or keywords such as codes included in IPC, FI, Fterm, and in the contents of an application.

For example, a case will be described in which the ratio of patents handled by a patent attorney “Tokkyo Taro” in a set of similar applications corresponding to the type of application “Decision to Grant a Patent” is higher than the ratio of patents corresponding to the characteristic information “Patent Attorney=Tokkyo Taro” among all similar applications. A progress information output apparatus 200 according to the second embodiment outputs important characteristic “Patent Attorney=Tokkyo Taro” for the procedure type “Decision to Grant a Patent”. Thus, a user may understand that applications that include “Patent Attorney=Tokkyo Taro” are likely to receive the status of “Decision to Grant a Patent.”

A method according to a second embodiment for outputting important characteristics for each procedure type will be described. Hereunder, explanations that are similar to the progress information output apparatus according to the first embodiment will be simplified or omitted.

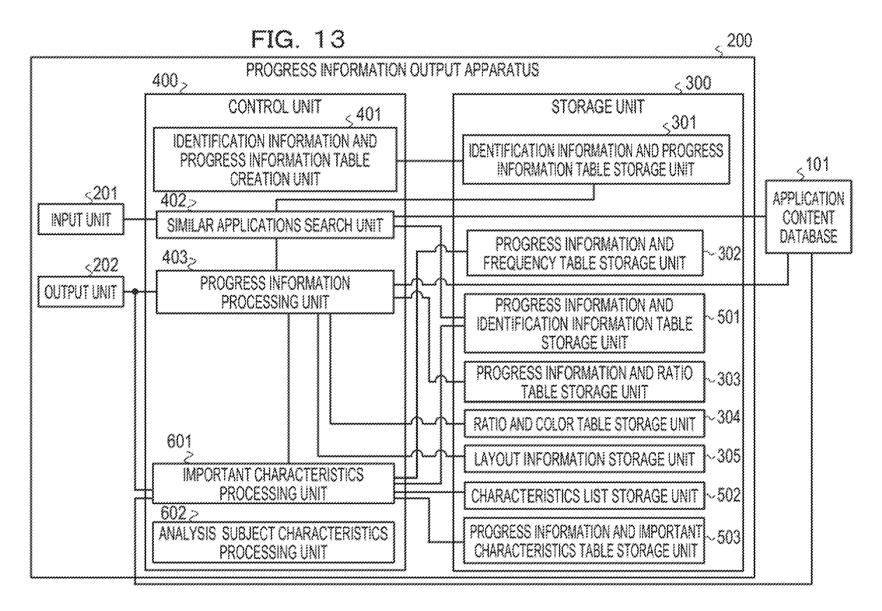

As illustrated in FIG. 13, the storage unit 300 of the progress information output apparatus 200 according to the second embodiment further includes a progress information and identification information table storage unit 501, a characteristics list storage unit 502, and a progress information and important characteristics table storage unit 503. FIG. 13 is a block diagram illustrating the configuration of the progress information output apparatus according to the second embodiment.

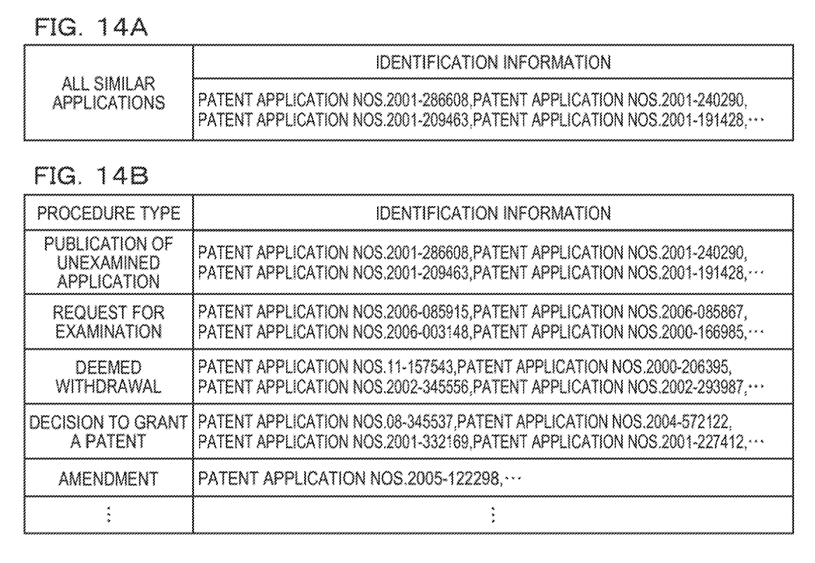

The progress information and identification information table storage unit 501 is connected to the similar applications search unit 402 and an important characteristics processing unit 601, which will be described later. As illustrated in FIG. 14B, the progress information and identification information table storage unit 501 stores identification information for identifying similar applications with progress information in association with each procedure type. FIG. 14 A and 14B illustrate a progress information and identification information table storage unit 501 according to the second embodiment. In other words, the progress information and identification information table storage unit 501 stores identification information included in the set of similar applications acquired by the similar applications search unit 402 in association with all of the corresponding procedure types.

The progress information and identification information table storage unit 501 stores all identification information included in the set of similar applications in association with “All similar applications” that indicate all similar applications included in the set of similar applications acquired by the similar applications search unit 402.

In the example illustrated in FIG. 14, the progress information and identification information table storage unit 501 stores identification information such as “Application No. 2001-286608” or “Application No. 2001-240290 in association with “All similar applications.” The progress and identification information table storage unit 501 stores the identification information for identifying similar applications with progress information “Publication of Unexamined Application” in association with the procedure type “Publication of Unexamined Application.” For example, the progress and identification information table storage unit 501 stores “Patent Application No. 2001-286608” or “Patent Application No. 2001-240290.” The progress information and identification information table storage unit 501 stores identification information for other procedure types as well.

Information stored in the progress information and identification information table storage unit 501 is input by the similar applications search unit 402 and used by the important characteristics processing unit 601.

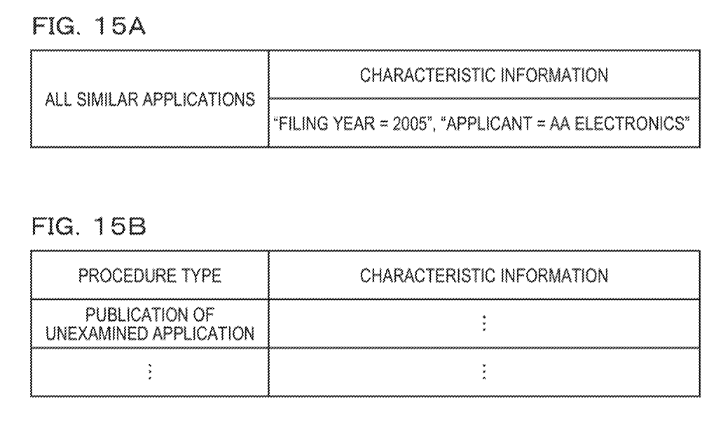

The characteristics list storage unit 502 is connected to the important characteristics processing unit 601. As illustrated in FIG. 15 B, the characteristics list storage unit 502 stores characteristic information acquired by the important characteristics processing unit 601 in association with each procedure type. FIGS. 15A and 15B illustrate the characteristics list storage unit 502 according to the second embodiment. The characteristics list storage unit 502 stores characteristic information acquired by the important characteristics processing unit 601 in association with all of the similar applications. In an example illustrated in FIG. 15, the characteristics list storage unit 502 stores information such as a filing year “2005” as characteristic information in association with “All similar applications.”

The characteristics list storage unit 502 stores characteristic information acquired by the important characteristics processing unit 601. For example, when forty applications with characteristic information “Filing year=2005” are included in the characteristic information for all similar applications, the characteristics list storage unit 502 stores forty applications corresponding to “Filing year=2005.”

Information stored in the characteristic list storage unit 502 is input by and used by the important characteristics processing unit 601.

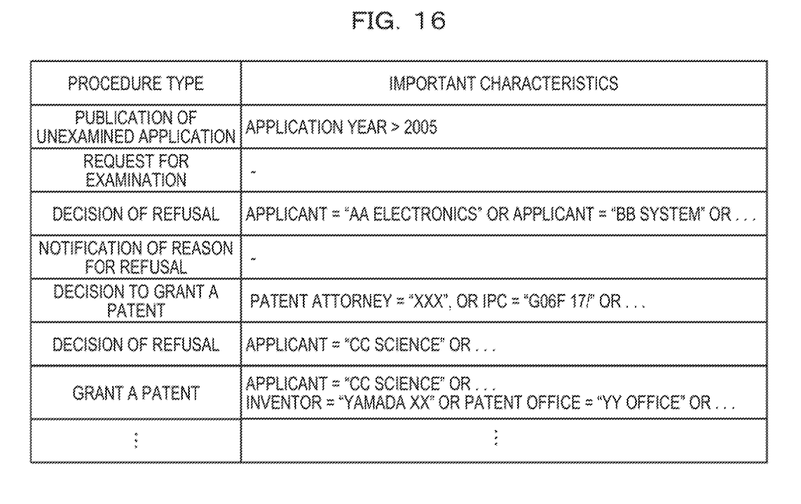

The progress information and important characteristics table storage unit 503 is connected to the important characteristics processing unit 601. As illustrated in FIG. 16, the progress information and important characteristics table storage unit 503 stores important characteristics acquired by the important characteristics processing unit 601 in association with each procedure type. FIG. 16 illustrates the progress information and important characteristics table storage unit 503 according to the second embodiment. In an example illustrated in FIG. 16, the progress information and important characteristics table storage unit 503 stores important characteristics such as “Applicant=AA electronics” in association with the procedure type “Deemed withdrawal.”

Important characteristics correspond to characteristics with a characteristic ratio per progress that significantly differs from a characteristic ratio for the same characteristic information. The characteristic ratio is calculated for the same characteristic information and is obtained by dividing the number of applications with the same characteristic information by the number of similar applications included in the set of similar applications. In other words, the characteristic ratio is the ratio of the number of similar applications classified for the same characteristic information among the total number of similar applications.

The same characteristic information may be, for example, characteristic information such as the same filing year, or may satisfy a specified condition such as “filed in 2005 or later.”

The characteristic ratio by progress is the ratio calculated for each type of characteristic information corresponding to each procedure type. The characteristic ratio per progress is obtained by dividing the number of applications with the same characteristic information per procedure type by the number of similar applications included in a set of procedure information. In other words, the characteristic ratio by progress is the ratio of the number of similar applications classified by the same characteristic information among the number of similar applications for the set of procedure information included in the set of characteristic information.

Information stored in the progress information and important characteristics table storage unit 503 is input by the important characteristics processing unit 601 and used by the important characteristics processing unit 601 and an analysis subject characteristics processing unit 602, which will be described later.

The control unit 400 of the progress information output apparatus 200 according to the second embodiment further includes the important characteristics processing unit 601 and the analysis subject characteristics processing unit 602.

According to the second embodiment, the similar applications search unit 402 is further connected to the progress information and identification information table storage unit 501. When the similar applications search unit 402 acquires a set of identification information for a set of similar applications, the similar applications search unit 402 inputs all of the identification information included in the set of identification information in association with “All similar applications” into the progress information and identification information table storage unit 501.

The similar applications search unit 402 inputs identification information into the progress information and identification information table storage unit 501 in association with each procedure type obtained by using the identification information included in a set of similar applications as a search key. For example, the similar applications search unit 402 inputs identification information “Patent Application No. 2001-30000” in association with the procedure type “Publication of Unexamined Application” and in association with the procedure type “Request for Examination” when “Publication of Unexamined Application” and “Request for Examination” are obtained using “Patent Application No. 2001-30000” as a search key.

The important characteristics processing unit 601 is connected to the application content database 101, the progress information and identification information table storage unit 501, the characteristics list storage unit 502, and the progress information and important characteristics table storage unit 503. The important characteristics processing unit 601 acquires characteristic information, calculates each characteristic ratio and characteristics ratio by progress, and outputs important characteristics.

Processing of acquiring characteristic information will be described. The important characteristics processing unit 601 searches the application content database 101 using each similar application included in a set of similar applications acquired by the similar applications search unit 402 as a search key. Then, the important characteristics processing unit 601 acquires a set of characteristic information items corresponding to the set of similar applications.

The important characteristics processing unit 601 searches the application content database 101 using identification information associated with “All similar applications” in the progress information and identification information table storage unit 501. Then, the important characteristics processing unit 601 acquires a set of characteristic information.

The important characteristics processing unit 601 inputs the set of characteristic information into the characteristics list storage unit 502. For example, the important characteristics processing unit 601 inputs the acquired set of characteristic information in association with “All similar applications.” For example, the important characteristics processing unit 601 inputs characteristic information such as “Filing year>2005” in association with “All similar applications.”

For each set of procedure information classified by procedure type by the progress information processing unit 403, the important characteristics processing unit 601 searches the application content database 101 using each similar application for each procedure information item included in the set of procedure information as a search key. Then, the important characteristics processing unit 601 acquires a characteristic information set for each procedure type.

The important characteristics processing unit 601 searches the application content database 101 for each procedure type using the identification information associated with a procedure type by the progress information and identification information table storage unit 501 as a search key. For example, the important characteristics processing unit 601 selects one of the procedure types such as the search information type “Publication of Unexamined Application” and searches the application content database 101 using “Patent Application No. 2001-286608” or “Patent Application No. 2001-240290” as a search key. Then, the important characteristics processing unit 601 acquires a set of characteristic information for each procedure type. Moreover, the important characteristics processing unit 601 judges whether or not processing for acquiring the set of characteristic information for all procedure types is performed, and the processing is repeated until the important characteristics processing unit 601 judges that all processing has been performed.

The important characteristics processing unit 601 inputs the set of characteristic information in association with each procedure type into the characteristics list storage unit 502.

A method for acquiring characteristic information will be further described. The important characteristics processing unit 601 acquires the contents of an application by searching the application content database 101 using identification information as a search key, and identifies and extracts characteristic information. For example, the important characteristics processing unit 601 extracts a filing year, an applicant, an inventor, a patent attorney, IPC, FI, or an Fterm from patent specifications. Moreover, the important characteristics processing unit 601 performs a morphological analysis of sentences of the patent specification included in the contents of an application and extracts a noun or consecutive noun groups as keywords. Thus, the important characteristics processing unit 601 acquires keywords.

The calculation of the characteristic ratio will be described. The important characteristics processing unit 601 classifies characteristic information included in the set of characteristic information acquired for all of the similar applications for each of the same characteristic information items. Then, the important characteristics processing unit 601 counts the number of characteristic information items for each type of classified same characteristic information.

For example, the important characteristics processing unit 601 classifies characteristic information included in the set of characteristic information associated with the procedure type “All similar applications.” For example, the important characteristics processing unit 601 counts the number of characteristic information indicating the same filing year among filing years extracted as characteristic information. For example, the important characteristics processing unit 601 counts “40” when there are forty pieces of characteristic information indicating the filing year “2005.”

The same characteristic information may be, for example, the same filing year, or information that satisfies a specified condition such as “filed in 2005 or later.”

The important characteristics processing unit 601 calculates each characteristic ratio by dividing the counted number for each same characteristic information by the number of similar applications included in the set of similar applications. For example, when the characteristic information “Filing Year=2005” is counted as “40”, and the number of similar applications is “100”, then the important characteristics processing unit 601 calculates the characteristic ratio as “0.4.” Likewise, the important characteristics processing unit 601 calculates a characteristic ratio for each same characteristic information item.

The calculation of the characteristic ratio by progress will be described. The important characteristics processing unit 601 classifies the characteristic information included in the set of characteristic information acquired for each procedure type by characteristic information. Then, the important characteristics processing unit 601 counts the number of characteristic information items for each type of the classified same characteristic information items.

For example, a case will be described in which the same characteristic information “Filing Year=2005” is included in all sets of characteristic information for procedure types. The important characteristics processing unit 601 counts the number of applications with the same characteristic information “Filing year=2005” for each procedure type.

For example, the characteristics list storage unit 502 stores the characteristic information acquired for each procedure type. The important characteristics processing unit 601 classifies characteristic information for each procedure type included in the set of characteristic information. Then, the important characteristics processing unit 601 calculates a characteristic ratio by progress for each of the classified same characteristic information items.

A case will be described in which the number of applications with the same characteristic information “Filing year=2005” is counted for each procedure type. The important characteristics processing unit 601 calculates, for each procedure type, a characteristic ratio by progress for the same characteristic information “Filing year=2005.”

Processing of output of important characteristics will be described. The important characteristics processing unit 601 calculates the difference between the characteristic ratio by progress for the same characteristic information and the characteristic ratio. For example, when the characteristic information is “Filing year=2005”, a difference between each characteristic ratio by progress calculated for the characteristic information “Filing year=2005”, and a characteristic ratio (for example, “0.4”) is calculated.

The important characteristics processing unit 601 judges whether or not the calculated difference is larger than a threshold value. If the difference is larger than the threshold value, the important characteristics processing unit 601 outputs the characteristic information for the procedure type to the output unit 202 by associating the set of characteristic information with the procedure type.

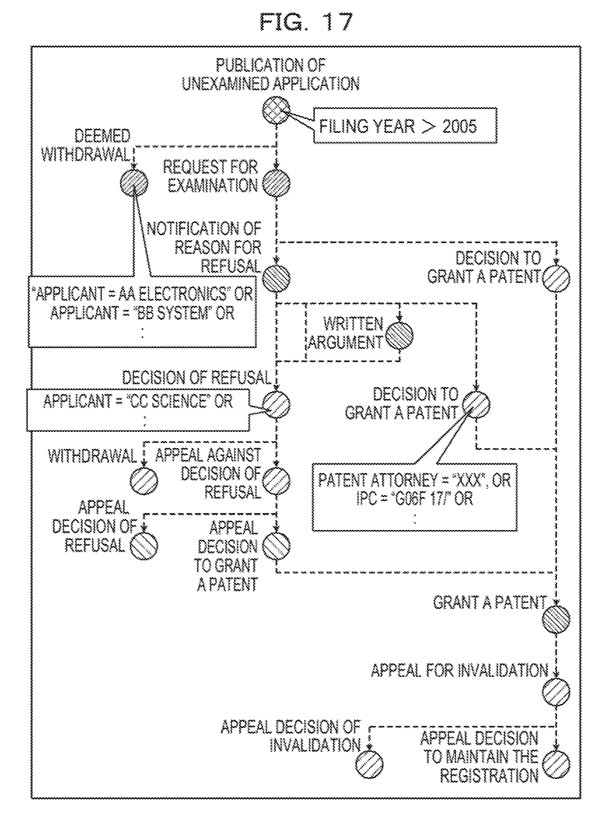

For example, the important characteristics processing unit 601 inputs characteristic information, the calculated difference of which is larger than the threshold value, as important characteristics into the progress information and important characteristics table storage unit 503 by associating the characteristic information with the procedure type. For example, the important characteristics processing unit 601 inputs important characteristics “Applicant=AA electronics” in association with the procedure type “Deemed withdrawal.” Then, as illustrated in FIG. 17, the important characteristics processing unit 601 outputs each important characteristic in association with a procedure type to the output unit 202. FIG. 17 illustrates an example of information output to the output unit 202 by the progress information processing unit 403 according to the second embodiment.

For instance, the important characteristics processing unit 601 uses a variable that depends on a ratio as a threshold value for judging whether or not the calculated difference is larger than a threshold value. For example, the important characteristics processing unit 601 may judge that the difference is larger than the threshold value when the characteristic ratio by progress is more than or equal to twice the characteristic ratio. Or, the important characteristics processing unit 601 may judge that the difference is larger than the threshold value when the characteristic ratio by progress is less than or equal to half of the characteristic ratio.

The important characteristics processing unit 601 may use a test method that reduces statistical randomness. For example, a test method may be used that reduces the chance that characteristic information is output as important characteristics to the output unit 202 because a difference happens to be larger than a threshold value. A case in which the important characteristics processing unit 601 uses the following Expression 1 will be explained, where “P” is the probability that the characteristic information exists in all applications, “p” is the probability that the characteristic information exists in a set of similar applications for a procedure type, and “n” is the number of similar applications for a procedure type.

t=(P−p)*sqrt(n)/sqrt((1−p)*p) Expression 1

If “t” is “|t|>t” compared to a percent point “t” obtained from a t-distribution table, the characteristic information is assumed to be an important characteristic. Note that “t” is determined by the number of samples and the rate of rejection. For example, “t” is “2.009” when a one-sided rate of rejection is “0.025” and the number of samples is “50” (from page 240, “12.2.1 Test for Population Mean” from Introductory Statistics, published by University of Tokyo Press).

The analysis subject characteristics processing unit 602 judges whether or not information the same as the important characteristics output in association with a procedure type by the important characteristics processing unit 601 is included in the contents of a given application. For example, the analysis subject characteristics processing unit 602 accepts the contents of an application to be analyzed from the input unit 201. The analysis subject characteristics processing unit 602 judges whether or not important characteristics are included in the contents of the application to be analyzed when the important characteristics processing unit 601 inputs important characteristics to the progress information and important characteristics table storage unit 503.

For example, the analysis subject characteristics processing unit 602 judges whether or not “Patent Attorney=xxx” is included in the contents of an application to be analyzed when the important characteristic “Patent Attorney=xxx” is input in association with “Decision to Grant a Patent” into the progress information and important characteristics table storage unit 503. In other words, the analysis subject characteristics processing unit 602 judges whether or not the patent attorney of the application to be analyzed is “xxx.”

The analysis subject characteristics processing unit 602 outputs a procedure type that includes the important characteristics judged to be included in the application to be analyzed to the output unit 202 when the analysis subject characteristics processing unit 602 judges that the important characteristics are included in the application to be analyzed.

A case will be described in which the important characteristic “Patent Attorney=xxx” is input in association with the procedure type “Decision to Grant a Patent” into the progress information and important characteristics table storage unit 503, and the contents of the application to be analyzed includes “Patent Attorney=xxx.” The analysis subject characteristics processing unit 602 outputs “Decision to Grant a Patent” in association with the application to be analyzed to the output unit 202.

In other words, the analysis subject characteristics processing unit 602 outputs a procedure type to which an application to be analyzed is applicable. For example, when applications that include “Patent Attorney=xxx” have a high possibility to be granted a patent, the analysis subject characteristics processing unit 602 outputs the progress information “Decision to Grant a Patent” to which an application to be analyzed is highly applicable.

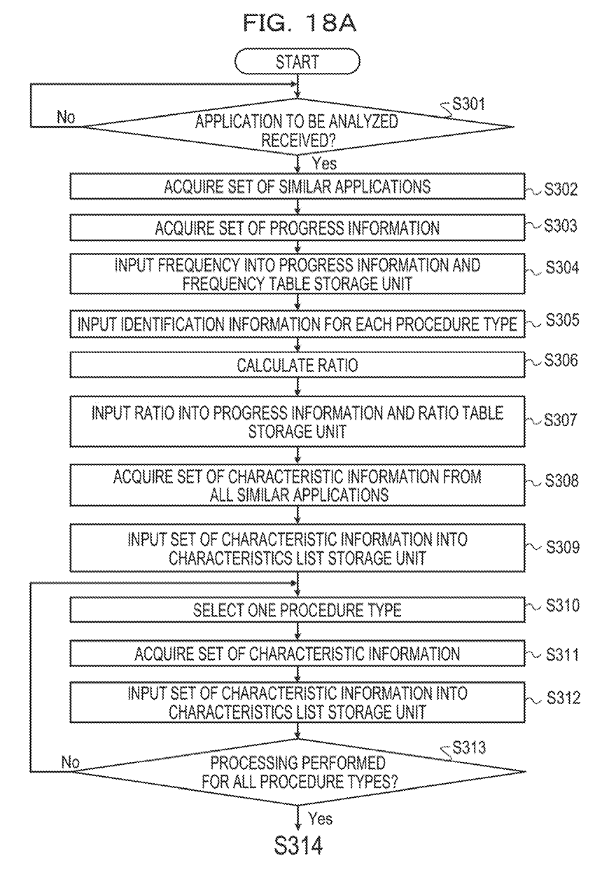

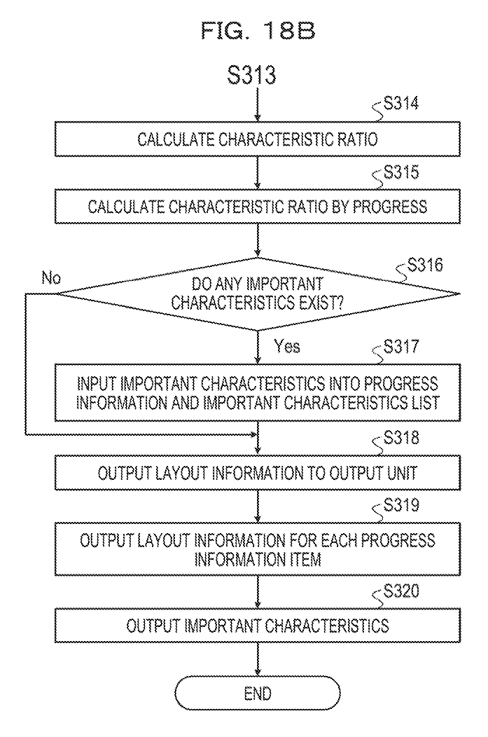

Now, a processing flow of outputting progress information according to the second embodiment will be described. FIG. 18A is a first flow chart and FIG. 18 B is a second flowchart illustrating a processing flow of outputting progress information according to the second embodiment.

As illustrated in FIG. 18, the progress information output apparatus 200 according to the second embodiment receives an application to be analyzed, and subsequently inputs a frequency into the progress information and frequency table storage unit 302 (Operations from S301 to S304). The similar applications search unit 402 inputs identification information for each procedure type (Operation S305). In other words, the similar applications search unit 402 inputs identification information included in the set of similar applications in association with each procedure type acquired, by using the identification information as a search key, into the progress information and identification information table storage unit 501.

Then, the progress information processing unit 403 calculates a ratio for each procedure type (Operation S306), and inputs the ratio into the progress information and ratio table storage unit 303 (Operation S307).

Then, the important characteristics processing unit 601 acquires a set of characteristic information from all similar applications (Operation S308). In other words, the important characteristics processing unit 601 searches the application content database 101 using each similar application included in the set of similar applications acquired by the similar application search unit 402. Then, the important characteristics processing unit 601 acquires a set of characteristic information for the set of similar applications. Subsequently, the important characteristics processing unit 601 inputs the set of characteristic information to the characteristics list storage unit 502 (Operation S309).

The important characteristics processing unit 601 selects one of the procedure types (Operation S310), and acquires a set of characteristic information (Operation S311). In other words, the important characteristics processing unit 601 selects one of the procedure types, such as the type of search information “Publication of Unexamined Application,” and searches the application content database 101 for the “Publication of Unexamined Application” using, for example, “Patent Application No. 2001-286608” or “Patent Application No. 2001-240290” as a search key. Thus, the important characteristics processing unit 601 acquires a set of characteristic information for each procedure type and inputs the set of characteristic information into the characteristics list storage unit 502 (Operation S312).

Moreover, the important characteristics processing unit 601 judges whether or not processing has been performed for all procedure types (Operation S313). If the important characteristics processing unit 601 judges the processing has not been performed for all procedure types (Operation S313: No), the important characteristics processing unit 601 repeats operations S310 to S312.

If the important characteristics processing unit 601 judges that all the processing has been performed for all procedure types (Operation S313: Yes), the important characteristics processing unit 601 calculates a characteristic ratio (Operation S314). The important characteristics processing unit 601 calculates a characteristic ratio by progress (Operation S315) and judges whether or not any important characteristics exist (Operation S316). For example, the important characteristics processing unit 601 calculates the difference between each characteristic ratio by progress and each characteristic ratio for each same characteristic information, and judges whether or not the calculated difference is larger than a threshold value.

If the important characteristics processing unit 601 judges that important characteristics exist (Operation S316: Yes), the important characteristics processing unit 601 inputs the important characteristics into the progress information and important characteristics table storage unit 503 (Operation S317). For example, the important characteristics processing unit 601 inputs the important characteristic “Applicant=AA electronics” in association with the procedure type “Deemed withdrawal.”

The important characteristics processing unit 601 sends the analysis results, which includes the layout information and progress information calculated by the progress information processing unit 403 to the output unit 202 (Operation S318 and S319) and outputs the important characteristics (Operation S320).

Among operations illustrated in FIG. 18, Operations from S301 to S304 correspond to Operations from S201 to S204. Likewise, Operation S306 corresponds to Operation S205, and Operation S307 corresponds to Operation S206. Moreover, Operation S318 corresponds to Operation S207, and Operation S319 corresponds to Operation S207.

As described above, the progress information output apparatus 200 according to the second embodiment calculates a characteristic ratio by progress and a characteristic ratio and calculates a difference between the two for each same characteristic information. If the calculated difference is larger than a threshold value, the progress information output apparatus may output characteristic information in association with a procedure type included in the set of characteristic information to the output unit 202. Thus, the progress information output apparatus 200 may output a procedure type that may be applicable to each of the characteristics of similar applications. For example, when a similar application of a patent is in the state “Decision to Grant a Patent” and the characteristic information is “xxx Patent Office”, the progress information output apparatus 200 may display useful information for the patent business such as, if the handling of a patent application is submitted to “xxx patent office”, then the patent is likely to be “Decision to Grant a Patent”.

The progress information output apparatus 200 according to the second embodiment judges whether or not characteristic information the same as the important characteristics is included in the contents of an application to be analyzed. If the progress information output apparatus 200 judges that important characteristics are included in the application, the progress information output apparatus 200 may output the procedure type associated with the characteristic information that is judged to be included in the application to be analyzed to the output unit 202. Thus, the progress information output apparatus 200 may output a procedure type that may be applicable based on characteristics included in a given application. This enables the judgment, for example, that a patent application analyzed by the progress information output apparatus 200 may be granted with a high possibility when an inventor X and a patent attorney Y are frequently included in applications in states of “Decision to Grant a Patent”.

### Embodiment 3

Methods for calculating a frequency or a ratio are described in the first embodiment, however, this invention is not limited to these. For example, a comment on an application to be analyzed may be output.

Hereafter, as a third embodiment, a method to output a comment for an application to be analyzed will be explained. Note that similar explanations for the progress information output apparatus 200 in the first embodiment and the second embodiment will be briefly described, or will not be described.

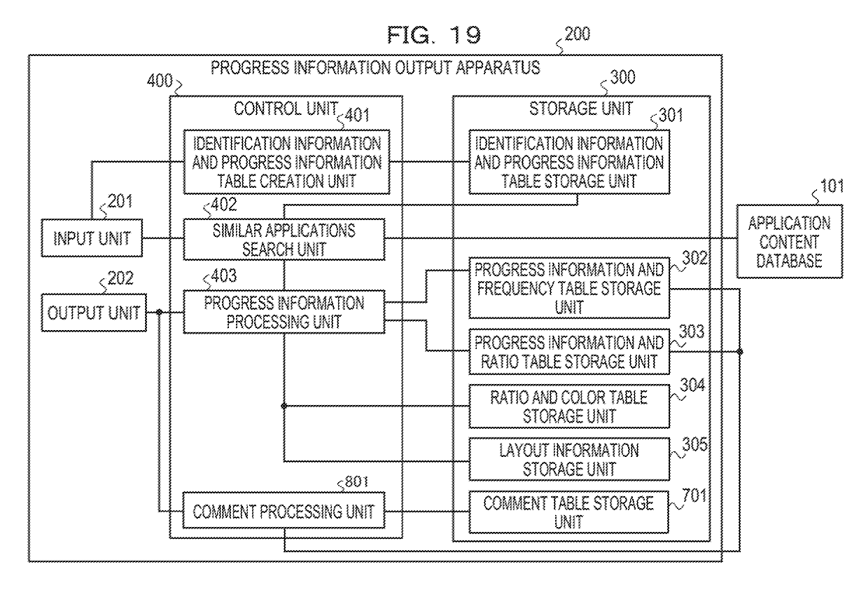

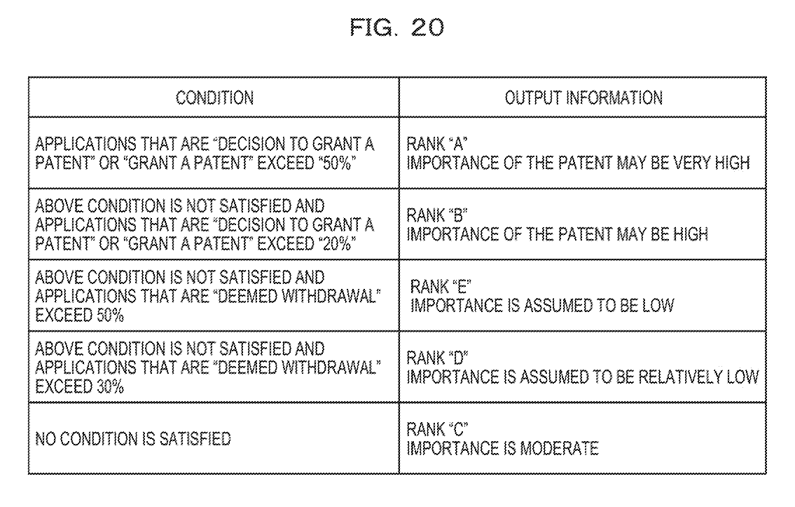

As illustrated in FIG. 19, a storage unit 300 of a progress information output apparatus 200 according to a third embodiment further includes a comment table storage unit 701, and a control unit 400 of the apparatus 200 includes a comment processing unit 801. FIG. 19 is a block diagram illustrating a configuration of the progress information output apparatus 200 according to a third embodiment.

The comment table storage unit 701 is connected to the comment processing unit 801, as illustrated in FIG. 20, and stores a condition in association with output information. The output information is set by a user as information to be output when a condition is satisfied. For example, such information may include a comment regarding importance set by a user. FIG. 20 illustrates the comment table storage unit 701 according to the third embodiment.

In the example illustrated in FIG. 20, a comment table storage unit 701 stores output information “Rank D, importance is assumed to be relatively low” in association with the condition “Above condition is not satisfied and applications that are ‘deemed withdrawal’ exceed 30%.”

Information stored in the comment table storage unit 701 is input by a user beforehand, and used by the comment processing unit 801.

The comment processing unit 801 is connected to the progress information and ratio table storage unit 303 and the comment table storage unit 701. The comment processing unit 801 judges whether or not the number counted for each procedure type or the analysis result obtained from the counted number by the progress information processing unit 403 satisfies a condition set by a user. For example, the comment processing unit 801 judges whether or not a calculated ratio for the procedure type “Decision to Grant a Patent” exceeds “50%.” If the ratio is judged to exceed “50%”, the comment processing unit 801 judges that the condition is satisfied (Refer to FIG. 20).

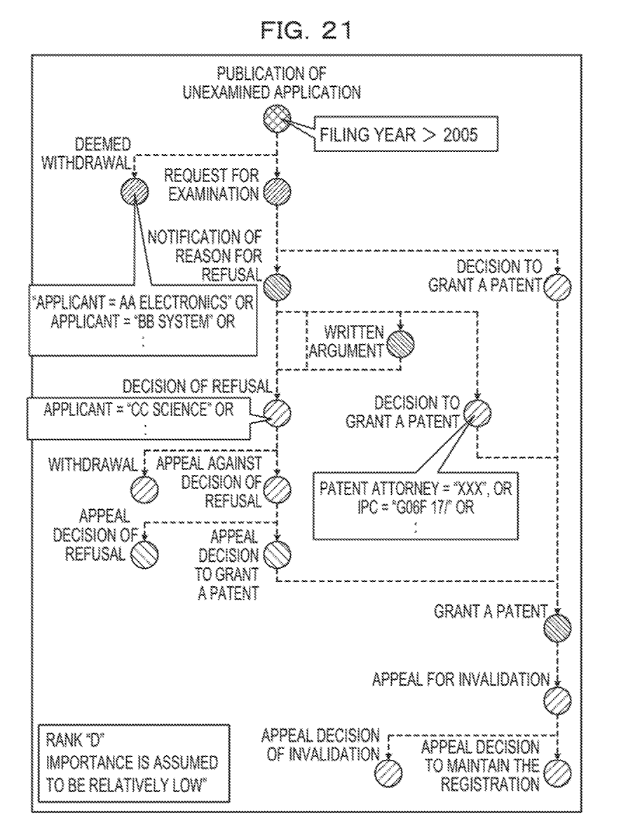

If a condition is satisfied, the comment processing unit 801 searches the comment table storage unit 701 using the satisfied condition as a search key, and acquires output information. Then, as illustrated in FIG. 21, the comment processing unit 801 outputs the output information to the output unit 202. FIG. 21 illustrates an example of information output from the progress information processing unit 403 according to the third embodiment.

In the example illustrated in FIG. 21, if the comment processing unit 801 judges the condition “the above condition is not satisfied, and ‘deemed withdrawal’ exceeds 30%” is satisfied, the comment processing unit 801 outputs the output information “Rank ‘D’, importance is assumed to be relatively low” to the output unit 202. FIG. 21 illustrates an example of information output when important characteristics are output as well.

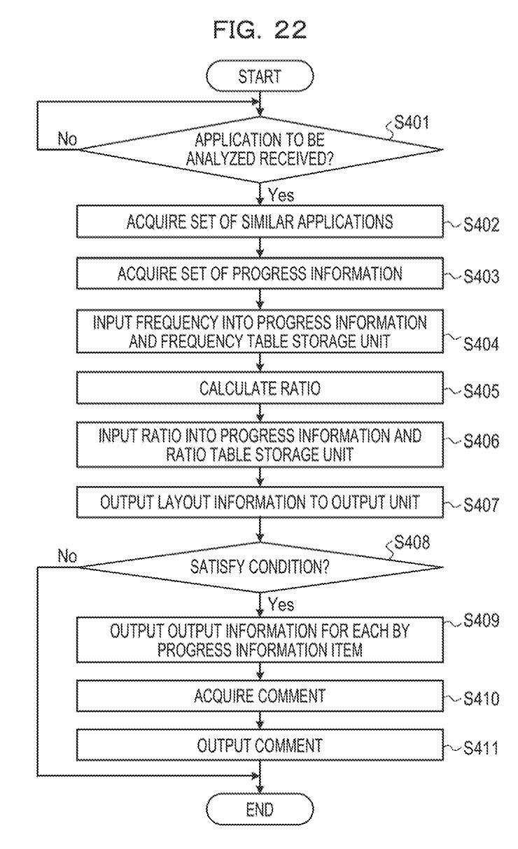

Now, a processing flow of outputting progress information in the third embodiment will be described. FIG. 22 is a flowchart illustrating the processing flow of outputting progress information according to the third embodiment.

As illustrated in FIG. 22, the progress information output apparatus according to the third embodiment receives an application to be analyzed, then outputs layout information (Operations from S401 to S407), the comment processing unit 801 judges whether or not an analysis result satisfies a condition (Operation S408).

If no condition is satisfied (Operation S408: No), the comment processing unit 801 completes the processing. If a condition is satisfied (Operation S408: Yes), the comment processing unit 801 outputs the output information that is associated with the condition for each progress information item (Operation S409). Subsequently, the comment processing unit 801 acquires a comment (Operation S410), and outputs the comment (Operation S411). In other words, if the comment processing unit 801 judges a condition “applications that are ‘Decision to Grant a Patent’ or ‘Grant a Patent’ exceeds 50%” is satisfied, the comment processing unit 801 outputs the output information “Rank A, importance of the patent may be very high” to the output unit 202.

Among operations illustrated in FIG. 22, operations from S401 to S407 correspond to operations S201 to S207. The operation S409 corresponds to operation S208.

As described above, the progress information output apparatus 200 according to the third embodiment judges whether or not the number counted for each procedure type or an analysis result obtained from the counted number satisfies a condition; and if the condition is satisfied, the apparatus outputs the output information that is associated with the condition. As a result, the progress information output apparatus 200 may display a comment for an application to be analyzed.

### Embodiment 4

Various embodiments of this invention have been described; however this invention may include other embodiments. Now, another embodiment will be described hereunder.

In the first embodiment, methods to output an analysis result and calculate a ratio as an analysis result have been described. However, this invention is not limited to these methods.

For each processing described in the above embodiments, the entire processing or a part of the processing that has been explained as automatic processing may be performed manually, or the processing that has been explained as manual processing may be performed automatically by applying a known method. For example, a user may manually acquire characteristic information from the contents of an application to be analyzed.

Moreover, processing procedures, control procedures, specific names, and information that includes various data or parameters in the above description or illustrated in the figures (for example, FIGS. 1 to 22) may be optionally changed unless otherwise specified.

Components of each of the devices illustrated in the figures include functional concepts, and are not necessarily physically configured as illustrated. This means the specific embodiments of distribution and integration of each of the devices are not limited to those illustrated in the figures, and a whole or a part of the embodiments may be physically distributed or integrated in a given unit depending on various loads or status of use. For example, the following units may be integrated into one storage unit: the identification information and progress information table storage unit 301, the progress information and frequency table storage unit 302, the progress information and ratio table storage unit 303, the ratio and color table storage unit 304, and the layout information storage unit 305. The application content database 101 may be physically integrated into the progress information output apparatus 200. The storage unit 300 may be physically separated from the progress information output apparatus 200.

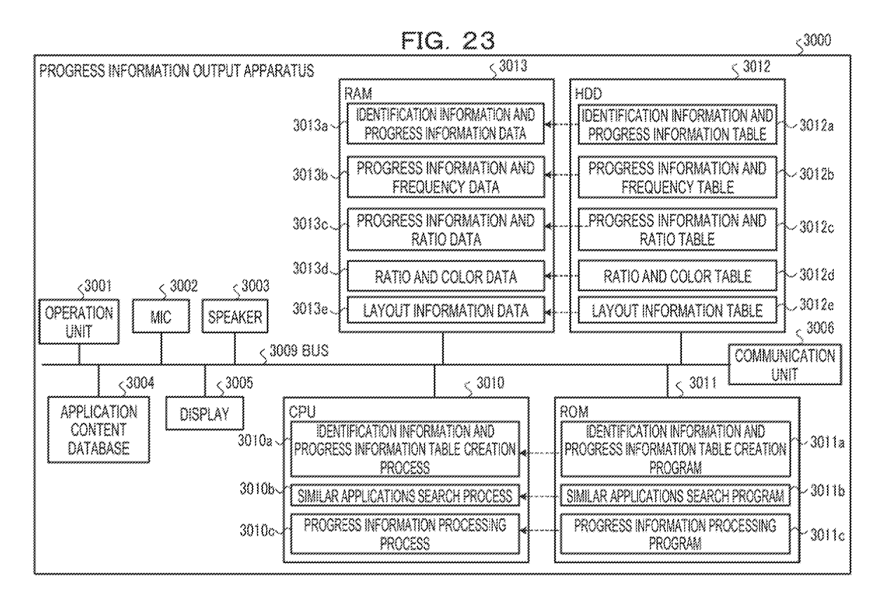

Various processing explained in the above embodiments may be achieved by causing a computer such as a personal computer and/or a workstation to execute a prepared program. Now, an example of a computer that executes a progress information output program having similar functions as the above embodiments will be explained by referring to FIG. 23. FIG. 23 illustrates a program of the progress information output apparatus 200 according to the first embodiment.

As illustrated in FIG. 23, a progress information output apparatus 3000 includes an operation unit 3001, a microphone 3002, a speaker 3003, an application content database 3004, a display 3005, a communication unit 3006, a central processing unit (CPU) 3010, a read only memory (ROM) 3011, a hard-disk drive (HDD) 3012, and a random access memory (RAM) 3013, and each of these units are interconnected via a bus 3009. The application content database 3004 corresponds to the application content database 101 illustrated in FIG. 2.

As illustrated in FIG. 23, the ROM 3011 stores the following control programs: an identification information and progress information table creation program 3011a, a similar applications search program 3011b, and a progress information processing program 3011c. These control programs achieve similar functions as the identification information and progress information table creation unit 401, the similar applications search unit 402, and the progress information processing unit 403 respectively described in the above embodiments. Note that the above programs may be integrated or separated as with each unit of the progress information output apparatus 200 illustrated in FIG. 2.

The CPU 3010 reads the programs in the ROM 3011 and executes the programs, thereby, as illustrated in FIG. 23, causing these programs to function as an identification information and progress information table creation process 3010a, a similar applications search process 3010b, and a progress information processing process 3010c, respectively. Note that the identification information and progress information table creation process 3010a corresponds to the identification information and progress information table creation unit 401, the similar applications search process 3010b corresponds to the similar applications search unit 402, and the progress information processing process 3010c corresponds to the progress information processing unit 403 illustrated in FIG. 2.

A HDD 3012 includes an identification information and progress information table 3012a, a progress information and frequency table 3012b, a progress information and ratio table 3012c, a ratio and color table 3012d, and a layout information table 3012e. Note that the table identification information and progress information 3012a corresponds to the identification information and progress information table storage unit 301, the progress information and frequency table 3012b corresponds to the progress information and frequency table storage unit 302, the table progress information and ratio 3012c corresponds to the progress information and ratio table storage unit 303, the ratio and color table 3012d corresponds to the ratio and color table storage unit 304, and the layout information table 3012e corresponds to the layout information storage unit 305 illustrated in FIG. 2.

The CPU 3010 reads the identification information and progress information table 3012a, the progress information and frequency table 3012b, the progress information and ratio table 3012c, the ratio and color table 3012d, and the layout information table 3012e and stores the relevant data in the RAM 3013. The CPU 3010 executes a progress information output program by using the identification information and progress information data 3013a, the progress information and frequency data 3013b, the progress information and ratio data 3013c, the ratio and color data 3013d, and the layout information data 3013e stored in the RAM 3013.

The progress information output apparatuses explained in these embodiments may be realized by causing a computer such as a personal computer and/or a workstation to execute a prepared program. The program may be transmission medium distributable through a network such as the Internet. Such a program may be stored in a computer-readable storage medium such as a hard disk, a flexible disk (FD), a compact disc ROM (CD-ROM), a magneto-optical (MO) disk, and a digital versatile disk (DVD), and executed by a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A progress information output method executed by a computer, the method comprising;
a similar applications acquiring process which acquires a set of similar applications, the contents of which are similar to the contents of a given application, by searching a first database that stores the contents of each application using information regarding the given application as a search key;
a progress information acquiring process which acquires a set of progress information corresponding to the set of similar applications, and searches a second database that stores, per application, progress information that indicates a progress of the given application and is an accumulation of procedure information that indicates a procedure conducted for the application, using each similar application included in the set of similar applications acquired in the similar applications acquiring process as a search key;
a counting process which counts the number of procedures for each classified type of procedure, and classifies, by type of procedure, procedure information included in the previously acquired sets of progress information acquired by the progress information acquiring process; and
an outputting process which outputs the number of procedures counted in the counting process in association with the procedure type, or an analysis result obtained from the number of procedures, to an output unit.

2. The progress information output method according to claim 1, wherein the outputting process calculates a ratio of the number of similar applications that correspond to the types of classified procedures to the number of similar applications included in the set of similar applications, by dividing the number of types of procedures counted in the counting process by the number of similar applications included in the set of similar applications, and outputs, as an analysis result in association with the corresponding type of procedure, the calculated ratio.

3. The progress information output method according to claim 1, further comprising;
a first characteristics acquiring process which searches the first database that also stores, for each application, characteristics information included in the contents of the applications, by using each similar application included in the set of similar applications acquired by the similar applications acquiring process as a search key, and acquires characteristics information corresponding to the similar applications;
a first characteristics number counting process which counts the number of the characteristics included in a set of characteristics information, by referring to the set of characteristics information acquired in the first characteristics acquiring process for each similar application included in the set of similar applications;
a first calculating process which calculates a ratio of the number of similar applications classified by the characteristics information to the number of all similar applications, by dividing the number counted in the first characteristics number counting process by the number of similar applications included in the set of similar applications;
a second characteristics acquiring process which searches the first database that also stores, for each application, the characteristics information included in the contents of the applications using a similar application included in procedure information of the set of procedure information classified for each procedure type in the counting process as a search key, and acquires the characteristics information corresponding to the similar applications;
a second characteristics counting process which counts the number of the characteristics by referring to the set of characteristics information acquired for each similar application included in the procedure information in the second acquiring characteristics process;
a second calculating process which calculates a ratio of the number of similar applications classified according to the characteristics information related to the procedure information to the number of corresponding similar applications, by dividing the number counted in the second characteristics acquiring process by the number of similar applications corresponding to the set of procedure information; and
a characteristics outputting process which outputs, via the output unit, the characteristic information in association with the procedure information by calculating a difference between the ratio calculated in the first calculation process and the ratio calculated in the second calculation process, for each characteristic information, if the calculated difference is larger than a threshold value.

4. The progress information output method according to claim 1, further comprising;
an analysis result judging process which judges whether or not the number of procedure types counted by the counting process or an analysis result obtained using the number satisfies a condition for the number or the analysis result set by a user; and
an output information outputting process which, when the condition is satisfied in the analysis result judging process, acquires output information by searching the second database that also stores the output information set by the user in association with the condition using the condition as a search key, and outputs the acquired output information via the output unit.

5. The progress information output method according to claim 3, further comprising;
a characteristics information judging process which judges whether or not information that is the same as the characteristics information output in association with a procedure type in the characteristics outputting process is included in the contents of a given application; and
a procedure information outputting process which, when the characteristics information is judged to be included in the contents of a given application in the characteristics information judging process, outputs, in association with a given application, the procedure type associated with the characteristics information.

6. A recording medium recording a progress information output program to be executed to perform a process, comprising:
firstly acquiring a set of similar applications, the contents of which are similar to the contents of a given application, by searching a first database that stores the contents of an application by each application using information regarding the contents of the given application as a search key;
secondly acquiring a set of progress information corresponding to the set of similar applications by searching a second database that stores the progress information that indicates the progress of the applications and is an accumulation of procedure information that indicates the procedures conducted for the applications, by using, as the search key, each of the similar applications included in the set of similar applications acquired by the firstly acquiring;
counting the number of procedures by procedure type obtained by classifying, by procedure type, the procedure information included in the set of progress information acquired by the secondly acquiring; and
outputting, in association with the type of procedure, the number of procedures counted by the counting or an analysis result obtained from the number of procedures to an output unit.

7. A progress information output apparatus comprising;
a storage unit storing progress information that is an accumulation of procedure information performed for an application and indicates the progress of the application;
a similar applications search unit searching a database that stores contents of the applications by application and acquiring a set of similar applications the contents of which are similar to a given application, and searching the storage unit using each similar application included in the acquired set of similar applications as a search key; and
a progress information processing unit counting the number of procedures included in the set of progress information acquired by the similar applications search unit and classified by procedure type, and outputting the number counted or an analysis result obtained using the counted number to an output unit.
